(19) United States
(12) Patent Application Publication
(10) Pub. No.: US 2006/0100830 A1
(43) Pub. Date: May 11, 2006

(54) Moment computations of nonuniform distributed coupled RLC trees with applications to estimating crosstalk noise

(75) Inventors: Herng-Jer Lee, Tao-Yuan (TW); Chia-Chi Chu, Tao-Yuan (TW); Wu-Shiung Feng, Tao-Yuan (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Tao-Yuan (TW)

(21) Appl. No.: 10/982,667

(22) Filed: Nov. 5, 2004

(51) Int. Cl. G06F 17/10

(52) U.S. Cl. 703/2

(57) ABSTRACT

A method for efficiently estimating crosstalk noise of nanometer VLSI interconnects is provided. In the invention, nanometer VLSI interconnects are modeled as nonuniform distributed RLC coupled trees. The efficiency and the accuracy of moment computation of distributed lines can be shown that outperform those of lumped ones. The inductive crosstalk noise waveform can be accurately estimated in an efficient manner using the linear time moment computation technique in conjunction with the projection-based order reduction method. Recursive formulas of moment computations for coupled RC trees are derived with considering both self inductances and mutual inductances. Also, analytical formulas of voltage moments at each node will be derived explicitly. These formulas can be efficiently implemented for crosstalk estimations.

### FIELD OF THE INVENTION

The present invention relates generally to a technique that use moment computation to estimate crosstalk noise of nanometer VLSI interconnects, and more particularly to the moment computation of nonuniform distributed RLC coupled trees and the projection-based order reduction method.

### BACKGROUND OF THE INVENTION

With the improvement of semiconductor producing technology, interconnect models get more and more important in the design flow of VLSI. While due to quality consideration, increasing timing frequency, decreasing ascending time, increasing online density and use of low-resistance materials, etc. in circuit design, designers should take into consideration of inductance effect at time of constructing interconnects. Also, due to the creation of nanotechnology in recent years, the importance of mutual inductance increases gradually. In the condition that RC is merely taken into consideration, the estimation of crosstalk noise is not accurate (refer to Interconnect Analysis and Synthesis written by C. K. Chang, J. Lillis, S. Lin and N. H. Chang, published by John Wiley and Sons Inc. in 2000). More and longer parallel nets will multiply capacitance coupling and increase current change on victim nets. Inductance added onto aggressor nets will cause more overshooting voltage, and further exacerbate noise on victim nets. The above two phenomena will lead to error in traditional estimation of crosstalk noise. According to the actual condition, inductance is necessary to be introduced to interconnect models to construct RLC coupled trees.

In the prior technology of estimating crosstalk noise, simulation is generally carried out in circuit. However, though the result of simulation carried in VLSI interconnects is considerably accurate, the computation complexity increases correspondingly. In order to solve this problem, the so-called Model-Order Reduction is gradually adopted in prior technology. (Provided by L. T. Pillage and R. A. Rohrer in “Asymptotic Waveform Evaluation for Timing Analysis,” IEEE Transaction on Computer-Aided Design of Integrated Circuits and Systems, Vol. 9, No. 4, pp. 352-366 in 1990, P. Feldmann and R. W. Freund in “Efficient Linear Circuit Analysis by Pade Approximation Via the Lanczos Process,” IEEE Transaction on Computer-Aided Design of Integrated Circuits and Systems, Vol. 14, No. 5, pp. 639-649 in 1995, and A. Odabasioglu, M. Celik and L. T. Pileggi in “PRIMA: Passive Reduced-order Interconnect Macromodeling Algorithm,” IEEE Transaction on Computer-Aided Design of Integrated Circuits and Systems, Vol. 17, No. 8, pp. 645-653 in 1998). This invention adopts order reduction method to estimate crosstalk noise. However, though the order reduction method can decrease the complexity of noise estimating computation, the computation is still too complicated in the process of noise optimization.

Among different prior technologies of model order reduction, most of them adopt moment matching method in crosstalk noise estimation in interconnects. In consideration of computation efficiency, many traditional methods to estimate crosstalk noise are developed in RLC coupled trees. The traditional technology includes One-Pole Model, 1P (A. Vittal, L. H. Cheng, M. Marek-Sadowska, K. P. Wang and S. Yang, “Crosstalk in VLSI Interconnects,” IEEE Transaction on Computer-Aided Design of Integrated Circuits and Systems, Vol. 18, pp. 1817-1824 (1999), and A. Vittal and M. Marek-Sadowska, “Crosstalk Recuction for VLSI,” IEEE Transaction on Computer-Aided Design of Integrated Circuits and Systems, Vol. 16, pp. 290-298 (1997), Modified One-Pole Model, M1P (Q. Yu and E. S. Kuh, “Moment Computation of Lumped and Distributed Coupled RC Trees with Application to Delay and Corsstalk Estimation,” Proceedings of the IEEE, Vol. 89, No. 5, pp. 772-788 (2001); Two-Pole Model, 2P (M. Kuhlmann and S. S. Sapatnekar, “Exact and Efficient Corsstalk Estimation,” IEEE Transaction on Computer-Aided Design of Integrated Circuits and Systems, Vol. 20, No. 7, pp. 858-866 (2001), and Q. Yu and E. S. Kuh, “Moment Computation of Lumped and Distributed Coupled RC Trees with Application to Delay and Crosstalk Estimation,” Proceedings of the IEEE, Vol. 89, No. 5, pp. 772-788 (2001), Stable Two-Pole Model, S2P (E. Acar, A. Odabasioglu, M. Celik and L. T. Pileggi, “S2P: A Stable 2-Pole RC Delay and Coupling Noise Metric,” Proceeding 9^{th} Great Lakes VLSI Symposium, March 1999, pp. 60-63), and Stable Three-Pole Model, S3P (Q. Yu and E. S. Kuh, “Moment Computation of Lumped and Distributed Coupled RC Trees with Application to Delay and Crosstalk Estimation,” Proceedings of the IEEE, Vol. 89, No. 5, pp. 772-788 (2001). The difference from the general model order reduction is that the above prior methods simply estimate peak value and its time of crosstalk noise, instead of waveform of crosstalk noise. Others existing American patents U.S. Pat. No. 5,481,695, U.S. Pat. No. 5,568,395, U.S. Pat. No. 5,596,506, U.S. Pat. No. 6,253,355, U.S. Pat. No. 6,253,359, U.S. Pat. No. 6,507,935, U.S. Pat. No. 6,536,022 and U.S. Pat. No. 6,662,149, etc. provide the application of crosstalk noise estimation. However, crosstalk noise in interconnects is probably non-monotonic waveform. None of the above estimating methods of capacitance crosstalk noise is suitable to estimate inductance crosstalk noise.

Some existing traditional technologies provide delay and noise formula with considering self inductance and mutual inductance. However, this model only applies to double parallel net (Y. Cao, X. Huang, D. Sylvester, N. Chang and C. Hu, “A New Analytical Delay and Delay and Noise Formulas with Considering Self Inductances and Mutual Inductances,” Proceedings of IEDM 2000, 2000, pp. 823-826); Other traditional technologies provide analytic formula of RLC transmission line computation delay and overshooting voltage, but without research of the influence of inductance on crosstalk noise analysis (M. H. Chowdhury, Y, I. Ismail, C. V. Kashyap and B. L. Krauter, “Performance Analysis of Deep Sub Micro VLSI Circuits in the Presence of Self and Mutual Inductance,” Proceedings of ISCAS 2002, 2002, pp. 197-200); In the existing technologies, recursive algorithm is provided to compute RLC tress moment in linear time (C. L. Ratzlaff and L. T. Pillage, “RICE: Rapid Interconnect Circuit Evaluation Using AWE,” IEEE Transaction on Computer-Aided Design of Integrated Circuits and Systems, Vol. 13, No. 6, pp. 763-776 (1994), Q. Yu and E. S. Kuh, “Exact Moment Matching Model of Transmission Lines and Application to Interconnect Delay Estimation,” IEEE Transaction on VLSI Symposium, Vol. 3, No. 2, pp. 311-322 (1995). However, this technology does not provide moment formula of coupled circuit. The inventor's previous application, “Method of VLSI to estimate crosstalk noise in lumped RIC coupled interconnects” provided an algorithm to estimate crosstalk noise in circuit by means of lumped RLC model with an aim at RLC coupled trees in VLSI. However, section number of lumped circuit should be increased to make the result of simulation more accurate, and this, on the contrary, increases the program EMS memory loads and the whole computation time. In addition, the inventor's previous application, “Designing method and proof of nanometer VLSI to estimate crosstalk noise in distributed RIC coupled interconnects” once provided an algorithm to estimate crosstalk noise in circuit by means of unitary and uniform RLC model with an aim at RLC coupled trees in nanometer VLSI. However, in the existing circuit designing flow, the design of part of circuit adopts nonuniform distributed interconnects to optimize circuit operation. Therefore, unitary and uniform disturbed interconnects fail to analyze this special design.

This invention aims at nonuniform distributed coupled RLC trees and carries out crosstalk noise estimation. The traditional technologies merely concentrate on distributed circuit that is necessary to circuit simulation. For example, R. Achar and M. S. Nakhla “Simulation on High-Speed Interconnects,” Proceeding IEEE, Vol. 89, No. 5, pp. 693-728, in 2001, A. C. Cangellaris, S. Pasha, J. L. Prince and M. Celik, “A New Discrete Transmission Line Model for Passive Model Order Reduction and Macromodeling of High-Speed Interconnections,” IEEE Transaction on Advanced Packing, Vol. 22, No. 3, pp. 356-364, in 1999, M. Celik and A. C. Cangellaris, “Simulation of Dispersive Multiconductor Transmission Lines by Pade Approximation Via the Lanczos Process,” IEEE Trans. Microwave. Theory Tech., Vol. 44, No. 12, pp. 2525-2533, in 1996, M. Celik and L. T. Pileggi, “Simulation of Lossy Multiconductor Transmission Lines Using Backward Euler Integration,” IEEE Trans. Circuits Syst. I-Fundam. Theor. AppI., Vol. 45, No. 3, pp. 238-243, in 1998, P. K. Gunupudi, R. Khazaka, M. S. Nakhla, T. Smy, and D. Celo, “Passive Parameterized Time-Domain Macromodels for High-Speed Transmission-Line Networks,” IEEE Trans. Microwave Theory Tech., Vol. 51, No. 12, pp. 2347-2354, in 2003, J. M. Wang, C. C. Chu, Q. Yu, and E. S. Kuh, “On Projection-Based Algorithms for Model-Order Reduction of Interconnects,” IEEE Trans. Circuits Syst. I-Fundam. Theor. Appl., Vol. 49, No. 11, pp. 1563-1585, in 2002 and Q. Xu and P. Mazumder, “Accurate Modeling of Lossy Nonuniform Transmission Lines by Using Differential Quadrature Methods,” IEEE Trans. Microwave Theory Tech., Vol. 50, No. 10, pp. 22233-2246 in 2002. However, up to now, there is still no efficient nonuniform distributed circuit model to estimate noise.

### SUMMARY OF THE INVENTION

This invention provides nonuniform distributed RLC coupled trees interconnects in nanometer VLSI, adopts moment matching method to efficiently estimate crosstalk noise while abandoning lumped circuit model with the traditional subsection method so as to shorten the computation time in the process of circuit simulation, and adopts nonuniform distributed model so as to be more approximate to the actual circuit design. Though in substance distributed circuit is a limitless series system, it approximately seems to be a limited series system in the form of multinomial moment model. Voltage and current moment model in nonuniform distributed circuit are approximate to a coordinate function multinomial, while the circuit parameter can be computed by means of data interpolation method. The moment model of every nonuniform distributed RLC coupled circuit includes one resistance, one independent power source and two independent voltage sources, which can reflect the information of resistance, capacitance, coupled capacitance, inductance, mutual inductance and moment. This invention additionally provides an order reduction moment computation formula. Each coefficient on multinomial moment model can be computed by order reduction computation and crosstalk estimating method of stable nonuniform distributed RLC coupled trees can be constructed by using projection-based order reduction method to compute the crosstalk noise of this order reduction series model, which can be regarded as the estimated value of crosstalk noise in the original circuit.

### DETAILED DESCRIPTION OF THE INVENTION

FIG. 1 is the input and output block diagram of computation device to implement this invention. This computation method should provide three input files, including circuit input signal 10, series q 12 of order reduction mothod and circuit parameter 14 of nonuniform ditributed circuit in RLC coupled trees. Firstly, in step 16, it is to compute the system moment {X₁,X₂, . . . ,X_{q}} of series q as the computation foundation of moment matching method, and then in step 18, it is to construct \hat{M} and \hat{N} matrix in series q order reduction method. In step 20, it is to compute the coefficient {b₁,b₂, . . . ,b_{q}} of equation |\hat{N}+s\hat{M}|=1+b₁s+b₂s²+ . . . +b_{q}s^{q}. In step 22, it is to update the moment values according to the input signals. In step 24, as to the series reduction transformation function

$$\hat{V} ( s ) = \frac{{a}_{0} + {a}_{1} s + ⋯ + {a}_{q - 2} {s}^{q - 1}}{1 + {b}_{1} s + ⋯ + {b}_{q - 1} {s}^{q - 1} + {b}_{q} {s}^{q}}$$

of q poles, it is to compute the coefficient {a₀,a₁, . . . ,a_{q-2}} based on the moment values in step 24 with moment matching method. In step 26, it is to show \hat{V}(s) in the form of pole-residue,

$$\hat{V} ( s ) = \frac{{k}_{1}}{s - {p}_{1}} + \frac{{k}_{2}}{s - {p}_{2}} + ⋯ + \frac{{k}_{q}}{s - {p}_{q}} ,$$

and then to transform it into \hat{v}(t)=k₁e^{p}^{₁}¹+k₂e^{p}^{₂}¹+ . . . +k_{q}e^{p}^{_{q}}¹ by Inverse Laplace. Finally in step 28, it is use \hat{v}(t) to estimate crosstalk voltage peak value. In step 30, the computation is finished. Each step is expatiated as follows:

This invention intends to use projection-base order reduction method to solve the above stability problem so as to create a stable order reduction method to solve the problem of crosstalk noise. This technique uses congruence transformation to project vector of the original n dimension to vector of order deduction q dimension, and q<<n, among which, q is determined in step 12.

In the nonuniform distributed circuit model provided by this invention, the crosstalk waveform can be expressed as \hat{v}(t)=k₁e^{p}^{₁}¹+k₂e^{p}^{₂}¹+ . . . +k_{q}e^{p}^{_{q}}¹, among which, kᵢ and p₁(1≦i≦q) are the pole and residue of q pole order reduction model \hat{V}(s). In order to ensure pole stability, it can be computed by using the root of equation |s\hat{M}+\hat{N}|=0, among which, matrix \hat{M} and matrix \hat{N} are obtained by integrated-congruence transforming matrix M and matrix N in the matrix of modified nodal analysis (MNA) by the prior technique.

The prior technology provides that limitless series distributed circuit is simulated in limited series model by using integrated-congruence transform. By means of this technology, MNA formula can be expressed as the following formula:

$$( s \underbrace{[ \begin{matrix}{\hat{M}}_{d} & 0 & 0 \\ 0 & C & 0 \\ 0 & 0 & L\end{matrix} ]}_{M} + \underbrace{[ \begin{matrix}{\hat{N}}_{d} & - {A}_{d} & 0 \\ {A}_{d}^{T} & G & {A}_{l} \\ 0 & - {A}_{l}^{T} & R\end{matrix} ]}_{N} ) \underbrace{[ \begin{matrix}{\hat{X}}_{d} ( s ) \\ {V}_{n} ( s ) \\ {I}_{L} ( s )\end{matrix} ]}_{X ( s )} = \underbrace{[ \begin{matrix}\begin{matrix}0 \\ {A}_{s}\end{matrix} \\ 0\end{matrix} ]}_{b} {V}_{s} ( s ) , \qquad ( 1 )$$

According to the circuit parameter provided in step 14, matrix M includes matrix \hat{M}_{d}, lumped capacitance matrix C and lumped inductance matrix L in nonuniform distributed order reduction method. Matrix N includes matrix \hat{N}_{d}, lumped resistance matrix R, lumped conductance matrix G and A_{d}, Aₗ incident matrix in nonuniform distributed order reduction model to balance Kirchhoff's Current Law (KCL) equation. Matrix X(s) is the transformation function of system condition variable, including system condition variable \hat{X}_{d}(s) in nonuniform distributed order reduction model, voltage vector Vₙ(s) in node and current vector I_{L}(s) in resistance-inductance branch; Matrix b includes incident matrix Aₛ showing the connecting method of input signal Vₙ(s) and circuit model. In formula (1), (s\hat{M}_{d}+\hat{N}_{d})\hat{X}_{d}(s)=A_{d}Vₙ(s) represents the circuit condition formula in nonuniform distributed order reduction model.

X(s) expands in Taylor Series when frequency s=0 and series k system moment vector is Xₖ[\hat{X}_{d,k} V_{u,k} I_{l,k}], among which, \hat{X}_{d,k}, V_{n,k} and I_{L,k} represent the system moment of \hat{X}_{d}(s), Vₙ(s) and I_{L}(s) respectively in series k. While the former q system moment can all be computed in step 16. FIG. 2 is the flow chart to compute transformation function moment of system condition variables, which will be expatiated in step 16. The computation technique is expatiated as follows:

Moment Model in Nonuniform Distributed RLC Coupled Circuit

One group of RLC coupled trees includes several independent RLC decoupled trees, coupled capacitance and mutual inductance. Each RLC decoupled tree includes floating resistance and self inductance, as well as capacitance that connects tree node and the ground. If the root of one independent RLC tree connects with one input voltage source, this tree is called aggressor tree. On the contrary, if the root of this RLC tree directly connects with the ground, this tree is called victim tree. If self inductance and mutual inductance are deleted from the circuit, it turns into the regular RC tree circuit model in the traditional estimating technique of crosstalk noise. In this invention, coupled interconnects are transformed into RLC coupled trees to analyze crosstalk noise.

The symbols are now detailed to demonstrate the complete RLC coupled trees. In consideration of N nonuniform distributed coupled transmission lines in FIG. 3 and one small section of RLC tree Tⁱ in a group of RLC coupled trees in FIG. 4, nⱼⁱ is the j node in tree Tⁱ, F(nⱼⁱ) is the father node of node fⱼⁱ. Lineⱼⁱ presents the nonuniform distributed RLC model between node nᵢ^{j} and F(nⱼⁱ), among which, x=0 and x=d present the immediate end and remote end respectively. While rⱼⁱ(x), lⱼⁱ(x) and cⱼⁱ(x) represent resistance, inductance and capacitance of unit length respectively on Lineⱼⁱ, and the conductance gⱼⁱ(x) of unit length is supposed to be neglected; iⱼⁱ(0,s) and vⱼⁱ(0,s) represent current and voltage multinomial of Lineⱼⁱ in the immediate end respectively, while iⱼⁱ(d,s) and vⱼⁱ(d,s) represent current and voltage multinomial of Lineⱼⁱ in the remote end respectively, c_{j,j}_{₁}^{i,i}^{₁}(x) and m_{j,j}_{₁}^{i,i}^{₁}(x) represent the coupled capacitance and mutual inductance of unit length between Lineⱼⁱ and Lineⱼ_{₁}ⁱ^{₁}; ccⱼⁱ(x) and mmⱼⁱ(x) represent the aggregation of coupled capacitance and mutual inductance of Lineⱼⁱ respectively. Pⱼₖⁱ represents the routes Pⱼⁱ of root from nⱼⁱ to Tⁱ, and the common route of root route Pₖⁱ from nₖⁱ to Tⁱ. The aggregation of nⱼⁱ ancestor nodes is defined as A(nⱼⁱ), including route P_{F(j)}ⁱ, i.e. all nodes in root route from F(nⱼⁱ) to Tⁱ so as to make Â(nⱼⁱ)={{A(nⱼⁱ)−n₀ⁱ}∪nⱼⁱ}. On the contrary, D(nⱼⁱ)={nₓⁱ|nⱼⁱεA(nₓⁱ)} represents the aggregation of nⱼⁱ descendant nodes, which is other defined as \hat{D}(nⱼⁱ)={nⱼⁱ∪D(nⱼⁱ)}. Generally speaking, coupling affect is not limited to take function on two nearest lines, especially inductance coupling affect. Therefore, this invention provides a model covering the general coupling condition. Each aggregation of ccⱼⁱ(x) and mmⱼⁱ(x) may probably include many coupled capacitance and mutual inductance, all of which can be solved efficiently.

The voltage transformation function on node nⱼⁱ is defined as Vⱼⁱ(s), and the transformation function of current passing by nⱼⁱ is defined as Iⱼⁱ(s). V₀ⁱ(s)=Vₛⁱ represents the voltage of root n₀ⁱ in circuit trees, among which, Vₛⁱ represents the voltage source connecting between root of tree Tⁱ (i.e. n₀ⁱ) and the ground. In case Vₛⁱ=1, tree Tⁱ is regarded as an aggressor tree. On the contrary, tree Tⁱ can be regarded as a victim tree. Vⱼⁱ(s) and Iⱼⁱ(s) expands in Taylor Series in case s=0, then

$${V}_{j}^{i} ( s ) = {\sum }_{k = 0}^{∞} {V}_{j , k}^{i} {s}^{k} and$$

$${I}_{j}^{i} ( s ) = {\sum }_{k = 0}^{∞} {I}_{j , k}^{i} {s}^{k} ,$$

among which, V_{j,k}ⁱ is called the voltage moment in series k of Vⱼⁱ(s), and I_{j,k}ⁱ is called the current moment in series k of Iⱼⁱ(s). The voltage moment −V_{j,l}ⁱ in the first series on node nⱼⁱ is the common Elmore delay model. This invention will compute the moment V_{j,k}ⁱ and I_{j,k}ⁱ in series k according to each node nⱼⁱ in tree structure.
Moment Computation in Nonuniform Distributed RLC Coupled Tree Interconnects

This invention intends to transform the lumped circuit between RLC coupled trees nⱼⁱ and its father node F(nⱼⁱ) in the prior technology (the previous application “Method of VLSI to estimate crosstalk noise in lumped RIC coupled interconnects” by the inventor) into nonuniform distributed circuit Lineⱼⁱ. Make vⱼⁱ(x,s), iⱼⁱ(x,s) and iₑ_{ⱼ}ⁱ(x,s) represent the transformation functions to input signals of the voltage, current and capacitance current of any coordinate point x in Lineⱼⁱ respectively, among which, x=0 represents the immediate end of the line, x=d represents the remote end of the line. Making use of Laplace Transformation, the Telegrapher's Equation of the relation of voltage and current in Lineⱼⁱ can be shown as follows:

$$\frac{\partial {v}_{j}^{i} ( x , s )}{\partial x} = - ( {r}_{j}^{i} ( x ) + {sl}_{j}^{i} ( x ) ) {i}_{j}^{i} ( x , s ) - {\sum }_{{mm}_{j}^{i}} ( {sm}_{j , {j}_{1}}^{i , {i}_{1}} ( x ) {i}_{{j}_{1}}^{{i}_{1}} ( x , s ) ) , \\ \begin{matrix}\frac{\partial {i}_{j}^{i} ( x , s )}{\partial x} = - {sc}_{jT}^{i} ( x ) {v}_{j}^{i} ( x , s ) + {\sum }_{{cc}_{j}^{i}} ( {sc}_{j , {j}_{1}}^{i , {i}_{1}} ( x ) {v}_{{j}_{1}}^{{i}_{1}} ( x , s ) ) \\ = {i}_{{c}_{j}}^{i} ( x , s )\end{matrix} \qquad ( 2 )$$

Among which,

$${c}_{jT}^{i} ( x ) = {c}_{j}^{i} ( x ) + {\sum }_{{cc}_{j}^{i}} {c}_{j , {j}_{1}}^{i , {i}_{1}} ( x )$$

(x) represents all capacitance values on Lineⱼⁱ, including self grounding capacitance and coupled capacitance aggregation. In consideration of FIG. 2 in step 102, v_{j,k}ⁱ(x), i_{j,k}ⁱ(x) and i_{c}_{_{j,k}}ⁱ(x) represent the moments in series k in case vⱼⁱ(x,s), iⱼⁱ(x,s) and i_{c}_{ⱼ}ⁱ(x,s) expands in Taylor's Series respectively. In case k=0, the capacitance in circuit can take equivalent effect as open circuit. Therefore, the current moment in series 0 i_{c}_{_{i,0}}ⁱ(x)=i_{j,0}ⁱ(d)=0, while the voltage moment in series 0 v_{j,0}ⁱ(x)=V_{j,0}ⁱ(0)=Vₛⁱ; In case k>0, the moment in series k is as follows:

$$\begin{matrix}{i}_{{c}_{j , k}}^{i} ( z ) = {c}_{jT}^{i} ( z ) {v}_{j , k - 1}^{i} ( z ) - {\sum }_{{cc}_{j}^{i}} ( {c}_{j , {j}_{1}}^{i , {i}_{1}} ( z ) {v}_{{j}_{1} , k - 1}^{{i}_{1}} ( z ) ) , & ( 3 ) \\ {i}_{j , k}^{i} ( x ) = {i}_{j , k}^{i} ( d ) + {\int }_{x}^{d} {i}_{{c}_{j , k}}^{i} ( z ) ⅆ z , & ( 4 ) \\ \begin{matrix}{v}_{j , k}^{i} ( x ) = {v}_{j , k}^{i} ( 0 ) - {\int }_{0}^{x} {r}_{j}^{i} ( z ) {i}_{{c}_{j , k}}^{i} ( z ) - {R}_{j}^{i} ( x ) {i}_{j , k}^{i} ( x ) - \\ {\int }_{0}^{x} {l}_{j}^{i} ( z ) {i}_{{c}_{j , k - 1}}^{i} ( z ) ⅆ z - {L}_{j}^{i} ( x ) {i}_{j , k - 1}^{i} ( x ) - \\ {\sum }_{{mm}_{j}^{i}} ( {\int }_{0}^{x} {m}_{j , {j}_{1}}^{i , {i}_{1}} ( z ) {i}_{{j}_{1} , k - 1}^{{i}_{1}} ( z ) ⅆ z + {M}_{j , {j}_{1}}^{i , {i}_{1}} ( x ) {i}_{{j}_{1} , k - 1}^{{i}_{1}} ( x ) )\end{matrix} , & ( 5 )\end{matrix}$$

Among which,

$${R}_{j}^{i} ( x ) = {\int }_{0}^{x} {r}_{j}^{i} ( z ) ⅆ z , \\ {L}_{j}^{i} ( x ) = {\int }_{0}^{x} {l}_{j}^{i} ( z ) ⅆ z , and$$

$${M}_{j , {j}_{1}}^{i , {i}_{1}} ( x ) = {\int }_{0}^{x} {m}_{j , {j}_{1}}^{i , {i}_{1}} ( z ) ⅆ z$$

represent the progressive resistance, inductance and mutual inductance in the position of x on Lineⱼⁱ respectively. Formula (3) and (4) can be deduced by Kirchhoff's Current Law (KCL), and formula (5) can be deducted by Kirchhoff's Voltage Law (KVL).

In order to simplify formula (4) and (5), the circuit current moment i_{c}_{_{j,k}}ⁱ(x) and voltage moment v_{j,k}ⁱ(x) to multinomial in step 104 are approximated:

$${i}_{{c}_{j , k}}^{i} ( x ) = {\sum }_{n = 0}^{{m}_{k}} {α}_{j , k , n}^{i} {x}^{n} , \\ {v}_{j , k}^{i} ( x ) = {\sum }_{n = 0}^{{p}_{k}} {β}_{j , k , n}^{i} {x}^{n} . \qquad ( 6 )$$

In addition, all circuit parameters, such as rⱼⁱ(x), lⱼⁱ(x), cⱼⁱ(x), ccⱼⁱ(x) and mmⱼⁱ(x) all approximate to q term multinomial, among which, each coefficient can be computed by Interpolation Technique. Therefore, step 106 is to compute the following multinomial from the multinomial multiplication integral in formula (5) with analytic method:

$${\int }_{0}^{x} {r}_{j}^{i} ( z ) {I}_{{c}_{j , k}}^{i} ( z ) ⅆ z = {\sum }_{n = 0}^{q + {m}_{k} + 2} {a}_{j , k , n}^{i} {x}^{n} , \\ {R}_{j}^{i} ( x ) {I}_{j , k}^{i} ( x ) -= {\sum }_{n = 0}^{q + {m}_{k} + 2} {b}_{j , k , n}^{i} {x}^{n} , \\ {\int }_{0}^{x} {l}_{j}^{i} ( z ) {I}_{{c}_{j , k - 1}}^{i} ( z ) ⅆ z = {\sum }_{n = 0}^{q + {m}_{k - 1} + 2} {c}_{j , k - 1 , n}^{i} {x}^{n} , \\ {L}_{j}^{i} ( x ) {I}_{j , k - 1}^{i} ( x ) = {\sum }_{n = 0}^{q + {m}_{k - 1} + 2} {d}_{j , k - 1 , n}^{i} {x}^{n} , \\ {\int }_{0}^{x} {m}_{j , {j}_{1}}^{i , {i}_{1}} ( z ) {I}_{{c}_{{j}_{1} , k - 1}}^{{i}_{1}} ( z ) ⅆ z = {\sum }_{n = 0}^{q + {m}_{k - 1} + 2} {e}_{j , k - 1 , n}^{i} {x}^{n} , \\ {M}_{j , {j}_{1}}^{i , {i}_{1}} ( x ) {I}_{{j}_{1} , k - 1}^{{i}_{1}} ( x ) = {\sum }_{n = 0}^{q + {m}_{k - 1} + 2} {f}_{j , k - 1 , n}^{i} {x}^{n} .$$

It should be noted that all coefficients can be computed by means of recursive moment computation in the prior technology (the previous application “Method of VLSI to estimate crosstalk noise in lumped RIC coupled interconnects” by the inventor); In formula (6), it can be seen that the multinomial in series 0 i_{c}_{_{j,0}}ⁱ(x) and _{j,0}ⁱ(x)=Vₛⁱ in case k=0, that is α_{j,0,0}ⁱ=0 and β_{j,0,0}ⁱ=Vₛⁱ so m₀=p₀=0; mₖ=q+(k−1)(2q+2) and pₖ=k(2q+2) in case k>0.

In step 108, it is to estimate whether a and β in coefficients can be computed, otherwise, return to step 106 by recursive computation. Step 110 is to finish the computation of current transformation function moment i_{c}_{_{j,k}}ⁱ(x) and voltage transformation function moment v_{j,k}ⁱ(x) in system variable.

Establishment of Matrix MNA of Simplified and Stable Pole Model

In consideration of FIG. 1 in step 18, make the congruence transformation matrix Q=└X₀ X₁ . . . X_{q-1}┘, then matrix MNA of the order reduction model can be computed by using the formula \hat{M}=Q^{T}MQ and \hat{N}=Q^{T}NQ. Make the elements in row k and row l in matrix \hat{M} and \hat{N} be \hat{m}_{k,l}=Xₖ₋₁^{T}MXₗ₋₁ and \hat{n}_{k,l}=Xₖ₋₁^{T}NXₗ₋₁ to observe the relation of different elements in \hat{M} and \hat{N}. We can discover the following two phenomena:

1. \hat{m}ᵢⱼ=−Xₗ₋₁^{T}NXⱼ=−\hat{n}_{i,j+1};

2. \hat{m}ᵢⱼ=Xⱼ₋₁^{T}MXₗ₋₁=−Xⱼ₋₁^{T}NXᵢ=−\hat{n}_{j,i+1}.

We can see from the prior technology (the previous application “Method of VLSI to estimate crosstalk noise in lumped RIC coupled interconnects” by the inventor), the steps to compute different elements in matrix \hat{N} can be further simplified. By observing the elements in the first line and the first row in matrix \hat{N}, we can discover the following relation:
1. \hat{n}ᵢ₁=0;
2. \hat{n}ᵢ₁(i>1), can be shown as I_{i,j-1}^{a}, which is the same as the current moment in series (i−1) of node n₁^{a} coming to the aggressor tree T^{a};
3. \hat{n}₁ᵢ=−\hat{n}₁ᵢ.

It can be computed by inserting the data into Xₖ=[\hat{X}_{d,k} V_{n,k} I_{L,k}]^{T}:
\hat{m}_{k,l}=−(\hat{X}_{d,k-1}^{T}\hat{M}_{d}\hat{X}_{d,l-1}+V_{n,k-1}^{T}CV_{n,l-1}+I_{L,k-1}^{T}LI_{L,k-1}) (7)

We can discover the following relation by observing formula (1):
NX₀=b
NXᵢ₊₁=−MXᵢ, for i=0,1, . . . ,q′
It can be computed by inserting the data into \hat{n}_{k,l}=Xₖ₋₁^{T}NXₗ₋₁

$$\begin{matrix}{\hat{n}}_{k , l} = - {X}_{k - 1}^{T} {MX}_{l - 2} \\ = - ( {\hat{X}}_{d , k - 1}^{T} {\hat{M}}_{d} {\hat{X}}_{d , l - 2} + {V}_{n , k - 1}^{T} {CV}_{n , l - 2} + {I}_{L , k - 1}^{T} {LI}_{L , l - 2}\end{matrix} , \qquad ( 8 )$$

FIG. 5 is the detailed flow chart of Step 18. From the above discussion, we can get the relation of different elements in matrix \hat{M} and matrix \hat{N}. Step 152 is the results of V_{n,k-1}^{T}CV_{n,l-1}, V_{n,k-1}^{T}CV_{m,l-1}, I_{L,k-1}^{T}LI_{L,l-1} and I_{L,k-1}^{T}LI_{L,l-2} in formula (7) and (8) related to the lumped circuit by means of the prior technology (the previous application “Method of VLSI to estimate crosstalk noise in lumped RIC coupled interconnects” by the inventor), as shown in step 156; While in step 158, \hat{X}_{d,k-1}^{T}\hat{M}_{d}\hat{X}_{d,l-1} and \hat{X}_{d,k-1}^{T}\hat{M}_{d}\hat{X}_{d,l-2} are related to nonuniform distributed circuit. After computing different coefficients of system variable transformation function in step 16, insert them into the formula to get the result. It should be noted that \hat{X}_{d,k-1}^{T}\hat{M}_{d}\hat{X}_{d,l-2} can be computed by the influence caused by different nonuniform distributed circuits, while the result of Lineⱼⁱ is as follows:

$${\int }_{0}^{d} {v}_{j , k - 1}^{i} ( z ) {i}_{{C}_{j , l - 1}}^{i} ( z ) ⅆ z = {\sum }_{n = 0}^{{p}_{k - 1} + {m}_{l - 1}} \frac{{g}_{j , n}^{i}}{n + 1} {d}^{n + 1} , \\ {\int }_{0}^{d} {i}_{j , k - 1}^{i} ( z ) ( {L}_{j}^{i} ( z ) {i}_{j , l - 3}^{i} ( z ) + {\sum }_{{mm}_{j}^{i}} ( {M}_{j , {j}_{1}}^{i , {i}_{1}} ( z ) {i}_{{j}_{1} l - 3}^{{i}_{1}} ( z ) ) ) ⅆ z = {\sum }_{n = 0}^{q + {m}_{k - 1} + {m}_{l - 3} + 3} \frac{{h}_{j , n}^{i}}{n + 1} {d}^{n + 1} .$$

Alike, the coefficients g_{j,n}ⁱ and h_{j,n}ⁱ in the above formula can be computed from multinomial by multiplication integral with analytic method.

In consideration of the circuit of two grounding capacitances and one coupled capacitance in FIG. 6(a), in case k>0, the output currents of nⱼⁱ and nⱼ_{₁}ⁱ^{₁} are as follows:
i_{c}_{_{j,k}}ⁱ=(c_{j,0}ⁱ+c_{j,j}_{₁}^{i,i}^{₁})v_{j,k-1}ⁱ−c_{j,j}_{₁}^{i,i}^{₁}vⱼ_{₁}_{,k-1}ⁱ^{₁},
i_{c}_{_{j,k}}=(cⱼ_{₁}_{,0}ⁱ^{₁}+c_{j,j}_{₁}^{i,i}^{₁})vⱼ_{₁}_{,k-1}ⁱ^{₁}−c_{j,j}_{₁}^{i,i}^{₁}vⱼ_{₁}_{,k-1}ⁱ^{₁},

Therefore, coupled capacitance can be regarded as two current sources. When there are many coupled capacitances in circuit, the model of each decoupled current moment is as follows:

$${i}_{{c}_{j , k}}^{i} = {c}_{jT}^{i} {v}_{j , k - 1}^{i} - {\sum }_{{c}_{j , {j}_{1}}^{i , {i}_{1}} ∈ {cc}_{j}^{i}} {c}_{j , {j}_{1}}^{i , {i}_{1}} {v}_{{j}_{1} , k - 1}^{{i}_{1}} .$$

The current moment i_{j,k}ⁱ in series k is the aggregation of capacitance current source in series k corresponding to each node after node

$${n}_{j , k}^{i} \cdot {i}_{j , k}^{i} = {\sum }_{{n}_{x}^{i} ∈ \hat{D} ( {n}_{j}^{i} )} {i}_{{C}_{x , k}}^{i} ,$$

then the equivalent circuit of coupled capacitance is as shown in FIG. 6(b).

Finally, in step 160, the moment model in RLC coupled circuit can be established, as shown in FIG. 7. In case x=0, we can get from formula (4) that
i_{j,k}ⁱ(0)=i_{j,k}ⁱ(d)+J_{j,k}ⁱ (9)
Among which,

$${J}_{j , k}^{i} = {\int }_{d}^{0} {I}_{{c}_{j , k}}^{i} ( z ) ⅆ z = {\sum }_{n = 0}^{{m}_{k}} \frac{{α}_{j , k , n}^{i}}{n + 1}$$

represents the aggregation of all capacitance currents on Lineⱼⁱ. Alike, formula (5) can be also expressed as

$${v}_{j , k}^{i} ( d ) = {V}_{j , k}^{i} ( 0 ) - {\sum }_{n = 0}^{q + {m}_{k} + 2} {b}_{j , k , n}^{i} {d}^{n} - {E}_{{LM}_{i , j}}^{i} - {E}_{j , k}^{i} \\ Among which , \\ {E}_{{LM}_{j , k}}^{i} = {\sum }_{n = 0}^{q + {m}_{k - 1} + 2} ( {d}_{j , k - 1 , n}^{i} + {\sum }_{{mm}_{j}^{i}} {f}_{j , k - 1 , n}^{i} ) {d}^{n} , \\ {E}_{j , k}^{i} = {\sum }_{n = 0}^{q + {m}_{k} + 2} {a}_{j , k , n}^{i} {d}^{n} + {\sum }_{n = 0}^{q + {m}_{k - 1} + 2} ( {c}_{j , k - 1 , n}^{i} + {\sum }_{{mm}_{j}^{i}} {e}_{j , k - 1 , n}^{i} ) {d}^{n} . \qquad ( 10 )$$

E_{j,k}ⁱ and E_{LM}_{_{j,k}}ⁱ represent the sudden decrease of voltage in voltage moment v_{j,k}ⁱ(0) when the capacitance current moment in series k and series k-1 passes by the resistance and induction on Lineⱼⁱ. When the circuit is RC coupled circuit, E_{LM}_{_{j,k}}=0.
Combination of Nonuniform Distributed Coupled Circuit with RLC Coupled Trees

In this invention, line(nⱼⁱ) is used to represent interconnects between nⱼⁱ and F(nⱼⁱ). In case line(nⱼⁱ)=1, it is to represent that there is one net between nⱼⁱ and F(nⱼⁱ), otherwise, line(nⱼⁱ)=0. Rⱼⁱ and Lⱼⁱ are the resistance and inductance on line(nⱼⁱ). C_{j,0}ⁱ is the grounding capacitance of nⱼⁱ; C_{j,j}_{₁}^{i,i}^{₁} is the coupled capacitance between nⱼⁱ and nⱼ_{₁}ⁱ^{ᵢ}; M_{j,j}_{₁}^{i,j}^{₁} is the mutual inductance between Lⱼⁱ and Lⱼ_{₁}ⁱ^{₁}; CCⱼⁱ is the aggregation that take effect of coupled capacitance with nⱼⁱ; MMⱼⁱ is the aggregation that take effect of mutual inductance with Lⱼⁱ; S(nⱼⁱ) is the aggregation of descendant nodes after nⱼⁱ.

In the computation of circuit model moment, in order to process nonuniform distributed coupled circuit at the same time, the current moment I_{j,k}ⁱ in series k in lumped circuit in the prior technology (the previous application “Method of VLSI to estimate crosstalk noise in lumped RIC coupled interconnects” by the inventor) is applied and modified as:

$${I}_{j , k}^{i} = {I}_{{C}_{j , k}}^{i} + {\sum }_{{n}_{y}^{i} ∈ S ( {n}_{j}^{i} )} {I}_{y , k}^{i} \\ Among which , \\ {I}_{y , k}^{i} = {I}_{y , k}^{i} + line ( {n}_{y}^{i} ) \cdot {J}_{y , k}^{i} . \qquad ( 11 )$$

Each current moment can be computed in the direction from leaf node in Tⁱ to root node. The relation between voltage moments V_{j,k}ⁱ and V_{F(i),k}ⁱ is as follows:

$${V}_{j , k}^{i} = {V}_{F ( j ) , k}^{i} - {R}_{j}^{i} {I}_{j , k - 1}^{i} - {L}_{j}^{i} {I}_{j , k - 1}^{i} - {\sum }_{{MM}_{j}^{i}} {M}_{j , {j}_{1}}^{i , {i}_{1}} {I}_{{j}_{1} , k - 1}^{{i}_{1}} - line ( {n}_{j}^{i} ) \cdot ( {E}_{j , k}^{i} + {E}_{{LM}_{i , j}}^{i} ) . \qquad ( 12 )$$

The complexity of recursive moment computations in nonuniform distributed circuit provided by this invention is O(nk²), among which, n is the number of nodes in tree model. On the other hand, the computation complexity applied in lumped circuit model is o(mk), among which, m is the number of nodes in the lumped circuit model. Generally speaking, in order to make the result of simulation of lumped circuit more accurate, it is to make m>nk, so the complexity of model moment computation of nonuniform distributed circuit provided in this invention is less than that of the computation in lumped circuit model.

Update Moment Values According to the Input Signals

In the previous moment computation, input waveform is supposed to expand to the frequency domain under the step function. However, the input signals in step 10 are probably random signals, which make the transformation function in step 22 after moment update as follows:

$$v ( s ) = {m}_{1}^{′} s + {m}_{2}^{′} {s}^{2} + {m}_{3}^{′} {s}^{3} + {m}_{4}^{′} {s}^{4} + {m}_{5}^{′} {s}^{5} ⋯ .$$

For example, if the input signal in step 10 is ramp function, it can be expressed as:

$$v ( t ) = \frac{t}{τ} u ( t ) - \frac{t}{τ} u ( t - τ ) + u ( t - τ ) ,$$

Among which, u(t) represents series function and 1/τ is the ramp rate of ramp function. After x(t) processes Laplace Transform, it can conclude:

$$V ( s ) = \frac{1}{s} ( 1 - \frac{τ}{2} s + \frac{{τ}^{2}}{6} {s}^{2} - \frac{{τ}^{3}}{24} {s}^{3} + \frac{{τ}^{4}}{120} {s}^{4} + ⋯ ) .$$

After coefficient matching, it can conclude:

$$\begin{matrix}{m}_{1}^{′} = {m}_{1} \\ {m}_{2}^{′} = {m}_{2} - \frac{τ}{2} {m}_{1} \\ {m}_{3}^{′} = {m}_{3} - \frac{τ}{2} {m}_{2} + \frac{{τ}^{2}}{6} {m}_{1} \\ {m}_{4}^{′} = {m}_{4} - \frac{τ}{2} {m}_{3} + \frac{{τ}^{2}}{6} {m}_{2} - \frac{τ}{24} {m}_{1} \\ {m}_{5}^{′} = {m}_{5} - \frac{τ}{2} {m}_{4} + \frac{{τ}^{2}}{6} {m}_{3} - \frac{{τ}^{3}}{24} {m}_{2} + \frac{{τ}^{4}}{120} {m}_{1} \\ ⋮\end{matrix} .$$

After moment update computation, it can conclude the voltage moment of each node in interconnects under random waveform input.
Crosstalk Noise Estimation in Nonuniform Distributed RLC Coupled Trees

In step 20, it is to apply matrix \hat{N} and \hat{M} in step 18 to compute the coefficient {b₁b₂, . . . ,b_{q}} of formula |\hat{N}+s\hat{M}|=1+b₁s+b₂s²+ . . . +b_{q}s^{q}. Later in step 24, make the order reduction formula \hat{V}(s) of q pole as follows:

$$\hat{V} ( s ) = \frac{{a}_{0} + {a}_{1} s + ⋯ + {a}_{q - 2} {s}^{q - 1}}{1 + {b}_{1} s + ⋯ + {b}_{q - 1} {s}^{q - 1} + {b}_{q} {s}^{q}} . \qquad ( 13 )$$

Therefore, when time t approximates to 0 or 8, its approximate crosstalk noise \hat{v}(t)=0. It is to make use of 2q-1 moments {V₁,V₂, . . . ,V_{2q-1}} of the original model to compute the unknown coefficient aᵢ(0≦i≦q-2).

In step 26, formula (13) is shown in the pole-residue form:

$$\hat{V} ( s ) = \frac{{k}_{1}}{s - {p}_{1}} + \frac{{k}_{2}}{s - {p}_{2}} + ⋯ + \frac{{k}_{q}}{s - {p}_{q}} , \qquad ( 14 )$$

Among which, pᵢ,i=1,2, . . . , q is the pole of \hat{V}(s), kᵢ is the residue corresponding to each pole pᵢ. It can be concluded by Inverse Laplace Transformation:
\hat{v}(t)=kᵢe^{p}^{₁}ⁱ+k₂e^{p}^{₂}ⁱ+ . . . +k_{q}e^{p}^{_{q}}ⁱ.
If crosstalk \hat{V}(s) reaches to the peak value in case t=tₘ, then \hat{v}′(tₙ)=0 and \hat{v}″(tₘ)<0. v(tₘ) is the estimated value of required crosstalk noise.
Simple Implementing Case

In order to prove the correctness of computation provided in this invention, FIG. 8 provides a model with three coupled circuits to research the crosstalk estimation technique by using this model. However, the application of this computation is not limited to this structure. In the figure, rectangle □ represents root nodes in the tree model, and round ∘ represents leaf node in the tree model.

2003 International Technology Roadmap of Semiconductors (ITRS) is introduced to the circuit parameter in the circuit model, among which, under the 90 nanometer semiconductor producing technology, the coefficient of line resistance is 22 mΩ-μm and the coefficient of dielectric value is 3.1. In the implementing case of this invention, it is to suppose that with the same width 10.88 μm, same thickness 0.58 μm and same height from the substrate 0.58 μm of all unitary and uniform metal lines, the resistance in unit length of metal line is 3.5 mΩ/μm and the grounding capacitance in unit length is 0.516 fF/μm after computation. Now it is to suppose that in nonuniform distributed circuit:
Line resistance is 3.50−8.53·10⁻³×+1.05·10⁻⁴x² mΩ/˜m,
Grounding capacitance is 0.55+3.31·10⁻³x−1.32·10⁻⁵x² fF/μm.
In addition, this implementing case adopts the inductance parameter in unit length of unitary and uniform circuit and introduces the data from the prior technology (Provided by A. Deutsch et al., “When are Transmission-Line Effects Important for On-Chip Interconnections?,” IEEE Trans. Microwave Theory Tech., Vol. 45, No. 10, pp. 1836-1846, in 1997). The inductance is 0.347 pH/μm. Now it is to suppose that in ununiform circuits,
The inductance is 0.27−6.60·10⁻⁴x+8.09·10⁻⁶x² pH/μm.

In this implementing case, coupled capacitance is supposed to be 0.47+6.61·10⁻³x−2.63·10⁻⁵x² fF/μm and the inductance is 0.12+6.60·10⁻⁴x−8.09·10⁻⁶x² pH/μm to prove the correctness of estimation device of crosstalk noise in this invention. Finally, the loading capacitance is supposed to be 50 fF. Noise peak values and their occurring time in different circuits should be taken into consideration due to the difference in structures, including length, coupled position, effective driving resistance and ascending time, etc. As shown in FIG. 8, there are five lengths of coupled line in net 1 L1={2,3,4,5}(mm), while there are also five lengths of coupled line in net 2, among which, the later is shorter than the former. In addition, other branches in FIGS. 8(b) and (c) are all 1 mm. In the testing case, the topology of net 1 remains fixed, while the coupled positions of net 2 will change: moving from the immediate end of net 1 to the remote end of line 1 with space of 1 mm. In each testing case, line 1 and line 2 are activated independently. In addition, the immediate ends of two lines connect with four effective driving resistances respectively: 3O-3O, 3O-30O, 30O-3O and 30O-30O. Moreover, the voltage source connecting on the aggressor tree includes two ascending times: the ramp functions 0.02 ns and 0.2 ns, and its unit intensity is normalized. Therefore, the computation provided in this invention may totally apply in 1640 testing cases.

In this invention, it is to make comparison with the traditional one-pole (1P) model and two-pole (2P) model, as well as three-pole (3P) model, four-pole (4P) model, five-pole (5P) and six-pole (6P) model in this invention. Table I lists the absolute error and comparative error by comparing the simulation result of crosstalk peak value and commercial software HSPICE, among which, resistance, capacitance and inductance are set to be put into sections per 20 μm by HSPICE. Among 1640 testing cases, there are 40 cases with unstable poles in 1P model; there are 15 cases with unstable poles in 2P model. In order to compare the efficiency and correctness of moment computation complexity in distributed model and lumped model, Table II lists the simulation results and their comparative errors of moment computation time in S6P lumped RLC trees, among which, the testing case is to cut the length of 1 mm into different sections.

In this invention, the phenomena observed will conclude in the following items:
1. The model by applying the method provided by this invention outperforms the traditional 1P and 2P models. Therefore, these traditional models are not suitable to apply in RLC coupled trees. Moreover, increase of the series of order reduction model will make the result more accurate.
2. In the absolute error list of S3P model in Table I, we can find that the average error is less than 10%, which seems to be quite suitable to crosstalk noise estimation. However, the comparative error of S3P model is not as accurate as expected. By observing the simulation result, we can find the computation efficiency and estimation accuracy of S6P model can get better balance point. FIG. 9 shows the crosstalk waveform of Spice, S3P, S4P and S6P in case the coupled circuit L1=L2=1 mm. We can clearly find that the waveform of S6P model is more accurate than the waveform of S3P and Spice.
3. In Table I, the stimulated computation time of S6P distributed circuit is 29.56 seconds with comparative error of 6.38%. While Table II shows that under the same comparative error, the simulation of lumped RLC circuit takes 902.13 seconds. Obviously, the efficiency and correctness of distributed circuit model are better than the lumped one.

In short, this invention provides a method for efficiently estimating crosstalk noise of nanometer VLSI interconnects, which can quickly estimate crosstalk noise in circuit nodes by cooperating with the present VLSI design flow. In this invention, VLSI interconnects are regarded to be RLC coupled trees including nonuniform distributed circuits and lumped ones, and projection-based recursive formulas of moment computations is provided to estimate the crosstalk noise waveform of circuit inductance.

TABLE I
Comparison list of absolute errors and comparative
errors of crosstalk noise waveform

| | 1P | 2P | S3P | S4P | S5P | S6P |
|---|---|---|---|---|---|---|
| Absolute | | | | | | |
| errors (%) | | | | | | |
| Maximum | 104.21 | 82.30 | 20.16 | 25.53 | 19.77 | 12.81 |
| Average | 16.27 | 12.66 | 4.57 | 3.16 | 2.23 | 1.26 |
| Minimum | 0.04 | 0.18 | 0.02 | 0 | 0 | 0 |
| Comparative | | | | | | |
| errors | | | | | | |
| (%) | | | | | | |
| Maximum | 312.44 | 182.24 | 57.85 | 73.48 | 63.57 | 49.89 |
| Average | 63.52 | 43.08 | 20.33 | 15.93 | 11.34 | 6.38 |
| Minimum | 0.12 | 1.49 | 0.03 | 0.02 | 0 | 0 |

TABLE II
S6P model is expressed in lumped RLC coupled
trees. 1 mm is cut into different sections to make comparison of
computation time and their comparative errors.

| | Number of sections | | | | |
|---|---|---|---|---|---|
| | 2 | 3 | 4 | 5 | 6 |
| Time | 32.34 | 56.35 | 63.46 | 81.03 | 95.22 |
| (second) | | | | | |
| Comparative | 8.80 | 7.68 | 7.18 | 6.97 | 6.80 |
| errors | | | | | |
| (%) | | | | | |
| Number | 10 | 20 | 30 | 40 | 50 |
| of | | | | | |
| sections | | | | | |
| Time | 167.06 | 325.23 | 478.96 | 657.48 | 902.13 |
| (second) | | | | | |
| Comparative | 6.63 | 6.46 | 6.42 | 6.40 | 6.39 |
| errors | | | | | |
| (%) | | | | | |

### BRIEF DESCRIPTION OF THE DRAWINGS

FIG. 1 is the input and output block diagram of computation device of implementing this invention.

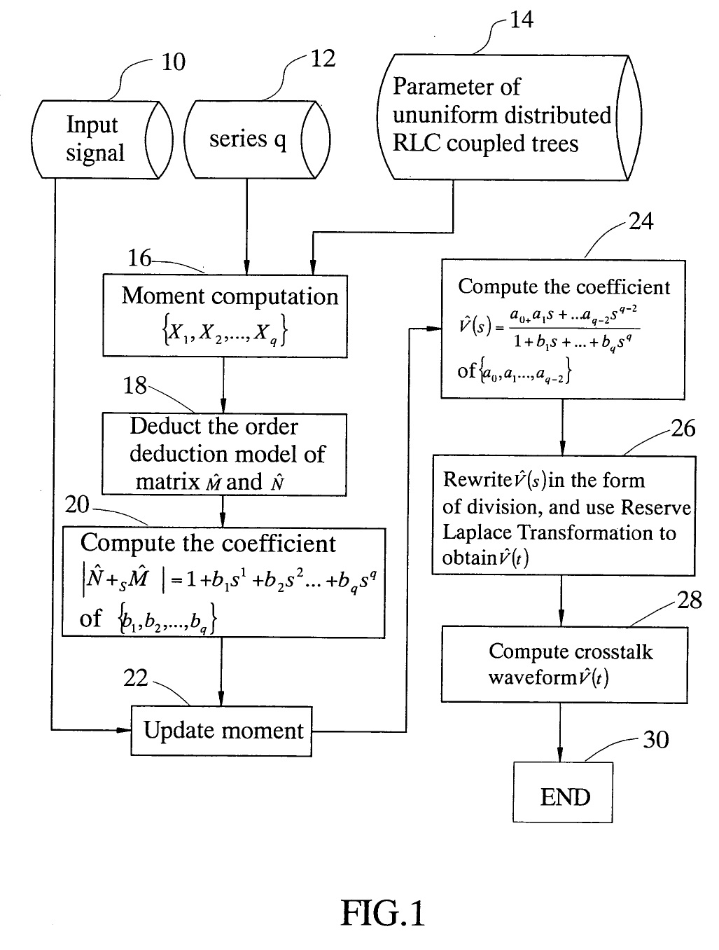

FIG. 2 is the computation flow chart to compute system moment.

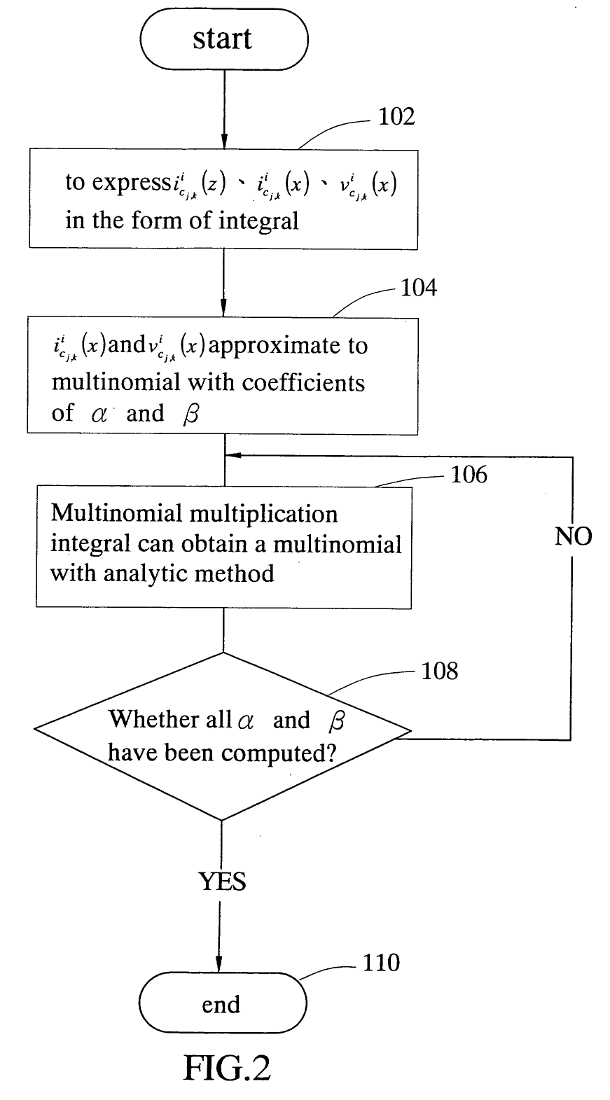

FIG. 3 is the nonuniform distributed transmission lines in coupled trees.

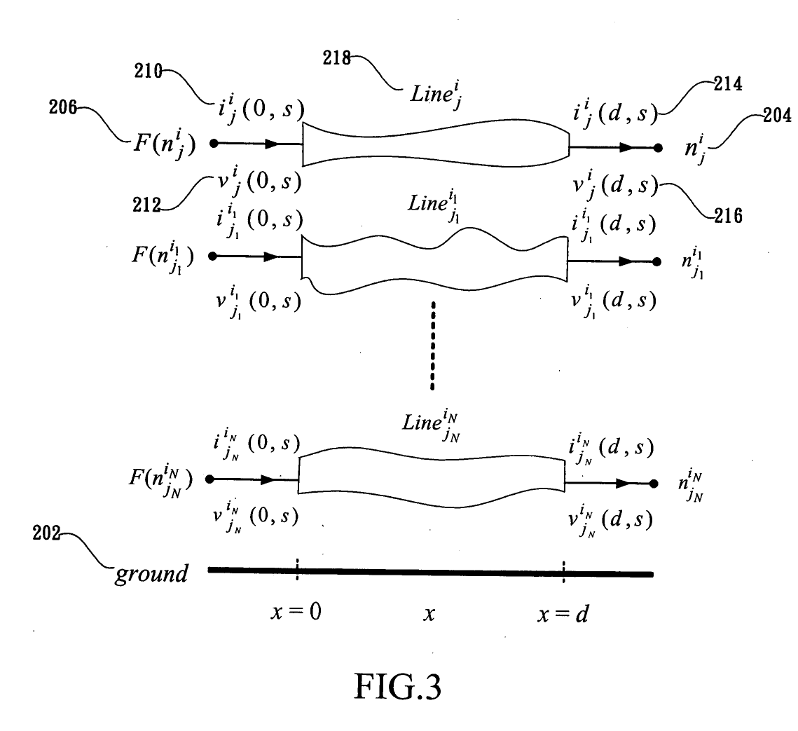

FIG. 4 is the classic expression of RLC coupled trees Tⁱ.

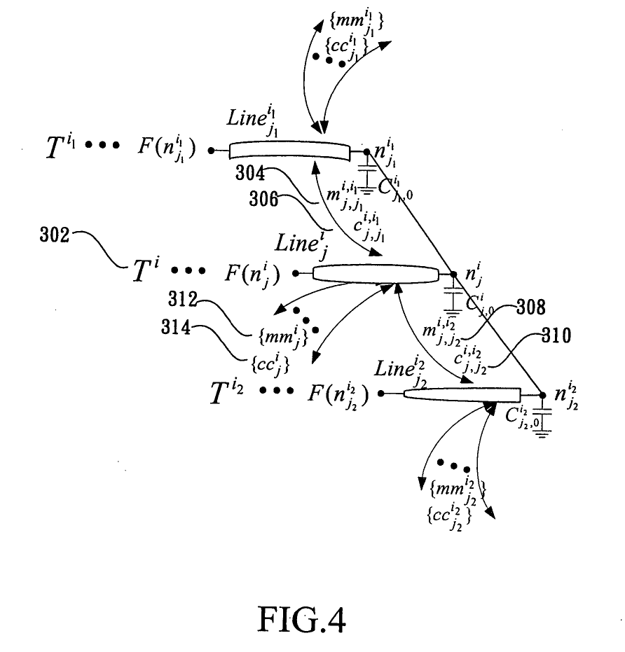

FIG. 5 is the flow chart of accomplishing nonuniform distributed circuit.

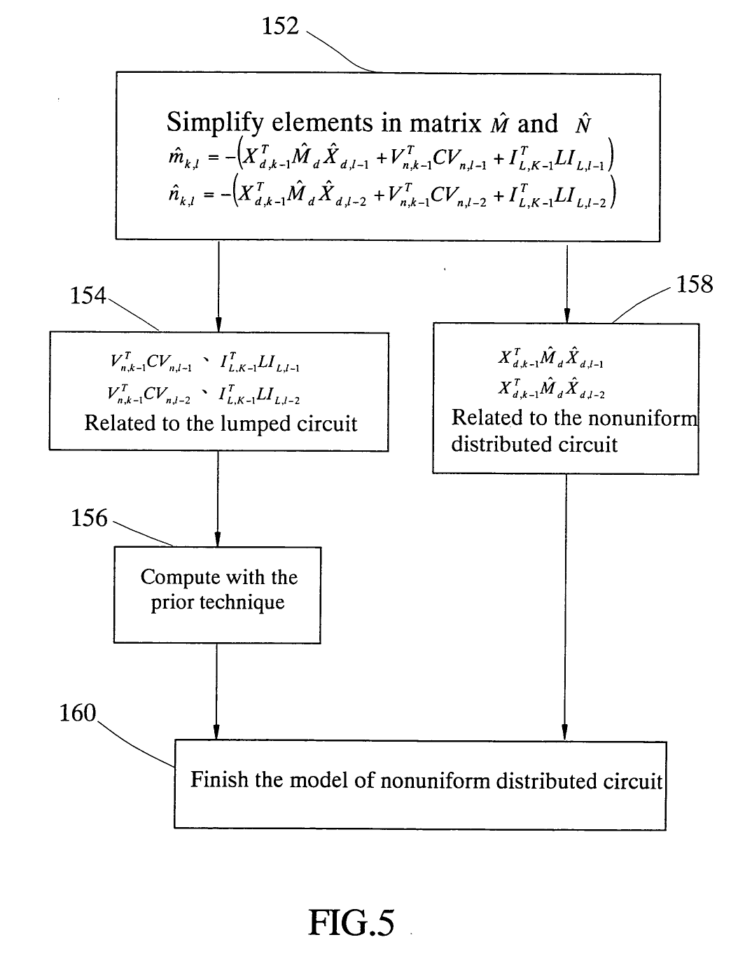

FIG. 6 is the conditions of coupled capacitance between two nodes: (a) is the original circuit; (b) is the equivalent moment model.

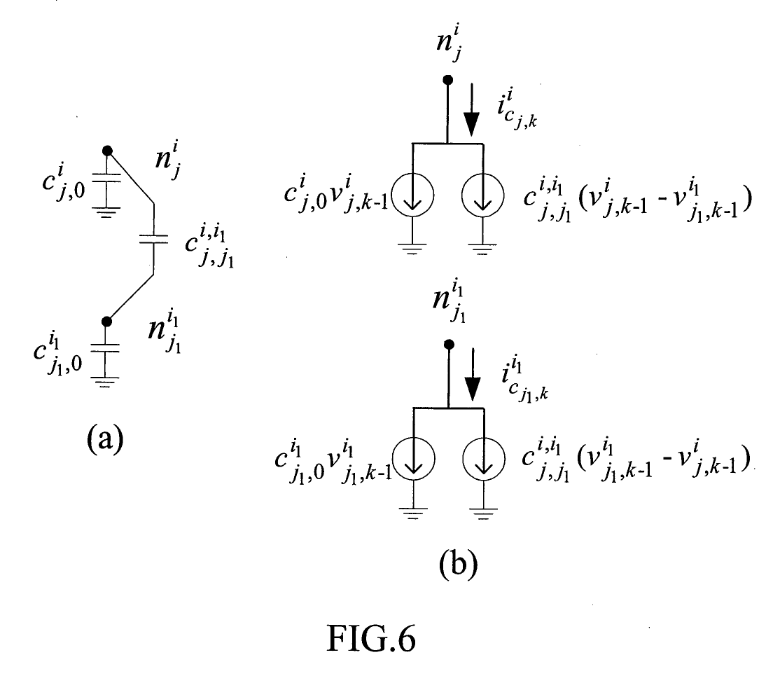

FIG. 7 is the moment model of nonuniform distributed RLC coupled circuit.

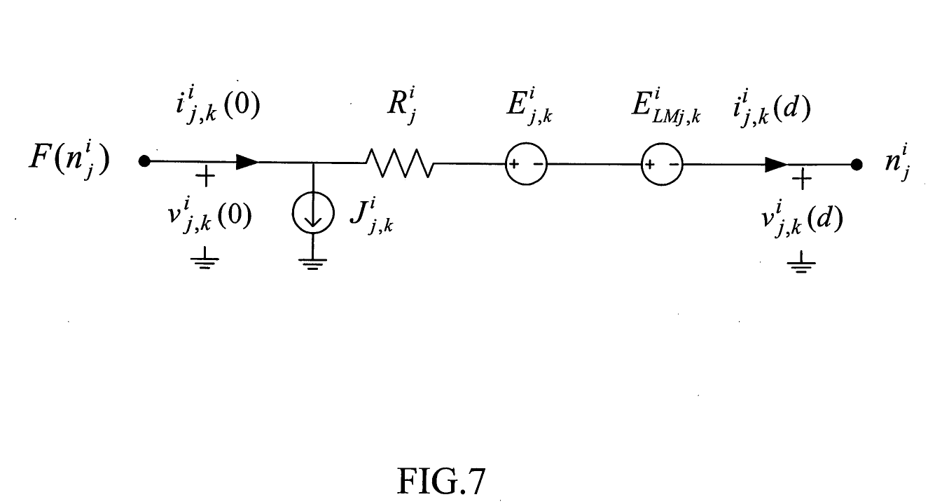

FIG. 8 is the condition of three RLC coupled trees with two parallel nets: (a) two parallel nets, (b) tree 1, (c) tree 2, among which, there are five lengths of coupled line of net 1 L1={2,3,4,5}(mm), while there are also five lengths of coupled line of net 2 L2={2,3,4,5}(mm), among which, the later is shorter than the former.

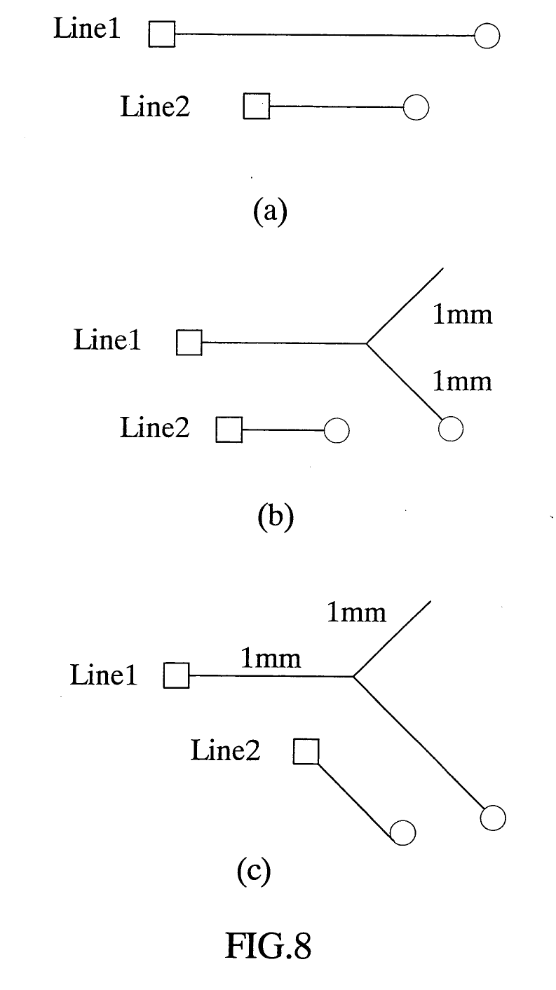

FIG. 9 is the simulation of crosstalk noise peak value of Spice, S3P, S4P and S6P.

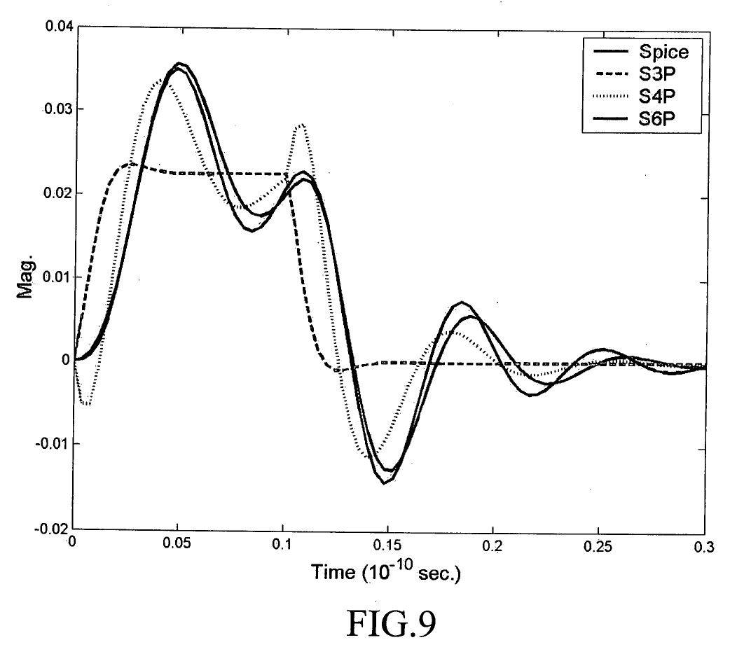

What is claimed is:

1. A method for estimating crosstalk noise in nonuniform distributed RLC coupled trees interconnects by making use of recursive formulas of moment computations in nanometer VLSI. In this line, the current moment i_{j,k}ⁱ(0) of one section of nonuniform distributed line Lineⱼⁱ in the immediate end (x=0) and the voltage moment V_{j,k}ⁱ(d) in the remote end (x=d) are
$${i}_{j , k}^{i} ( 0 ) = {i}_{j , k}^{i} ( d ) + {J}_{j , k}^{i} , \\ {v}_{j , k}^{i} ( d ) = {V}_{j , k}^{i} ( 0 ) - {\sum }_{n = 0}^{q + {m}_{k} + 2} {b}_{j , k , n}^{1} {d}^{n} - {E}_{{LM}_{i , j}}^{i} - {E}_{j , k}^{i} ;$$
$$Among which , \\ {J}_{j , k}^{i} = {\int }_{d}^{0} {I}_{{c}_{j , k}}^{i} ( z ) ⅆ z = {\sum }_{n = 0}^{{m}_{k}} \frac{{α}_{j , k , n}^{i}}{n + 1} , \\ {E}_{{LM}_{j , k}}^{i} = {\sum }_{n = 0}^{q + {m}_{k - 1} + 2} ( {d}_{j , k - 1 , n}^{i} + {\sum }_{m {m}_{j}^{i}}^{} {f}_{j , k - 1 , n}^{i} ) {d}^{n} , \\ {E}_{j , k}^{i} = {\sum }_{n = 0}^{q + {m}_{k} + 2} {a}_{j , k , n}^{i} {d}^{n} + {\sum }_{n = 0}^{q + {m}_{k - 1} + 2} ( {c}_{j , k - 1 , n}^{i} + {\sum }_{m {m}_{j}^{i}}^{} {e}_{j , k - 1 , n}^{i} ) {d}^{n} ;$$
Among which:
Superscript i represents it is the i tree on the line Tⁱ in the circuit model;
Subscript j represents the j node nⱼⁱ on the line Tⁱ, this node is the remote end (x=d) of this line;
vⱼⁱ(x,s) and i_{c}_{ⱼ}ⁱ(x,s) represent the transformation functions of voltage and capacitance current on Lineⱼⁱ respectively;
v_{j,k}ⁱ(x) and i_{c}_{_{j,k}}ⁱ(x) represent the coefficients (i.e. moment) in series k when vⱼⁱ(x,s) and i_{c}_{ⱼ}ⁱ(x,s) expand in Taylor Series respectively;
I_{c}_{_{j,k}}ⁱ(z) represents the capacitance current in Lineⱼⁱ;
E_{j,k}ⁱ represents the sudden decrease of voltage on voltage moment v_{j,k}ⁱ(0) resulted by the capacitance current moment in series k and series k-1 passing by the resistance on Lineⱼⁱ;
E_{LM}_{_{j,k}}ⁱ represents the sudden decrease of voltage on voltage moment v_{j,k}ⁱ(0) resulted by the capacitance current moment in series k and series k-1 passing by the inductance on Lineⱼⁱ;
mmⱼⁱ is the aggregation of all mutual inductances related to Lineⱼⁱ;
α_{j,k,n}ⁱ is the coefficient in series k when i_{c}_{_{j,k}}ⁱ(x) expands in Taylor Series, i.e.
$${i}_{{c}_{j , k}}^{i} ( x ) = {\sum }_{n = 0}^{{m}_{k}} {α}_{j , k , n}^{i} {x}^{n} .$$

2. A method for estimating crosstalk noise in nonuniform distributed RLC coupled trees interconnects by making use of recursive formulas of moment computations in nanometer VLSI as defined in claim 1, which expresses i_{c}_{_{j,k}}ⁱ(x) and v_{j,k}ⁱ(x) in the form of multinomial
$${i}_{{c}_{j , k}}^{i} ( x ) = {\sum }_{n = 0}^{{m}_{k}} {α}_{j , k , n}^{i} {x}^{n} , {v}_{j , k}^{i} ( x ) = {\sum }_{n = 0}^{{p}_{k}} {β}_{j , k , n}^{i} {x}^{n} ;$$
In case k=0, the multinomial in series 0 i_{j,0}ⁱ(x)=0 and v_{j,0}ⁱ(x)=Vₛⁱ represents α_{j,0,0}ⁱ=0 and β_{j,0,0}ⁱ=Vₛⁱ, so m₀=p₀=0; In case k>0, it can be deduced that mₖ=q+(k-1)(2q+2) and pₖ=k(2q+2); among which, the coefficients a, b, c, d, e, f can be computed with recursive formulas of moment computations:
$${\int }_{0}^{x} {r}_{j}^{i} ( z ) {I}_{{c}_{j , k}}^{i} ( z ) ⅆ z = {\sum }_{n = 0}^{q + {m}_{k} + 2} {a}_{j , k , n}^{i} {x}^{n} , \\ {R}_{j}^{i} ( x ) {I}_{j , k}^{i} ( x ) = {\sum }_{n = 0}^{q + {m}_{k} + 2} {b}_{j , k , n}^{i} {x}^{n} , \\ {\int }_{0}^{x} {l}_{j}^{i} ( z ) {I}_{{c}_{j , k - 1}}^{i} ( z ) ⅆ z = {\sum }_{n = 0}^{q + {m}_{k - 1} + 2} {c}_{j , k - 1 , n}^{i} {x}^{n} , \\ {L}_{j}^{i} ( x ) {I}_{j , k - 1}^{i} ( x ) = {\sum }_{n = 0}^{q + {m}_{k - 1} + 2} {d}_{j , k - 1 , n}^{i} {x}^{n} , \\ {\int }_{0}^{x} {m}_{j , {j}_{1}}^{i , {i}_{1}} ( z ) {I}_{{c}_{{j}_{1} , k - 1}}^{{i}_{1}} ( z ) ⅆ z = {\sum }_{n = 0}^{q + {m}_{k - 1} + 2} {e}_{j , k - 1 , n}^{i} {x}^{n} ,$$
$${M}_{j , {j}_{1}}^{i , {i}_{1}} ( x ) {I}_{{j}_{1} , k - 1}^{{i}_{1}} ( x ) = {\sum }_{n = 0}^{q + {m}_{k - 1} + 2} {f}_{j , k - 1 , n}^{i} {x}^{n} ;$$
Among which,
β_{j,k,n}ⁱ is the coefficient in series n when v_{j,k}ⁱ(x) expands in Taylor Series;
Rⱼⁱ(x) and Lⱼⁱ(x) represent the resistance and inductance of nonuniform distributed Lineⱼⁱ in coordinate x;
rⱼⁱ(z) and lⱼⁱ(z) represent resistance and inductance of unit length in Lineⱼⁱ respectively;
I_{j,k}ⁱ(x) represents the current transformation function input to node nⱼⁱ;
I_{c}_{_{j,k}}ⁱ(z) represents the capacitance current in Lineⱼⁱ;
m_{j,j}_{₁}^{i,i}^{₁} represents the mutual inductance between Lineⱼⁱ and the adjacent nonuniform distributed Lineⱼ_{₁}ⁱ^{₁};
M_{j,j}_{₁}^{i,i}^{₁} represent the mutual inductance between Lⱼⁱ and Lⱼ_{₁}ⁱ^{₁}.

3. As described in claim 1, the moment value and other multinomial coefficients computed with the method of estimating crosstalk noise in nonuniform distributed RLC coupled trees interconnects by making use of moment computations can be used to construct the order reduction model to estimate crosstalk noise waveform, among which, the result of nonuniform distributed Lineⱼⁱ is:
$${\int }_{0}^{d} {v}_{j , k - 1}^{i} ( z ) {i}_{{C}_{j , l - 1}}^{i} ( z ) ⅆ z = {\sum }_{n = 0}^{{p}_{k - 1} + {m}_{l - 1}} \frac{{g}_{j , n}^{i}}{n + 1} {d}^{n + 1} , \\ {\int }_{0}^{d} {i}_{j , k - 1}^{i} ( z ) ( {L}_{j}^{i} ( z ) {i}_{j , l - 3}^{i} ( z ) + {\sum }_{m {m}_{j}^{i}}^{} ( {M}_{j , {j}_{1}}^{i , {i}_{1}} ( z ) {i}_{{j}_{1} , l - 3}^{{i}_{1}} ( z ) ) ) ⅆ z = {\sum }_{n = 0}^{q + {m}_{k - 1} + {m}_{l - 3} + 3} \frac{{h}_{j , n}^{i}}{n + 1} {d}^{n + 1} ;$$
Among which,
i_{c}_{_{j,l-1}}ⁱ(z) is the capacitance current in RLC coupled model; Coefficients g_{j,n}ⁱ and h_{j,n}ⁱ can be computed from multinomial by multiplication integral with analytic method.
